(19) United States
(12) Patent Application Publication
(10) Pub. No.: US 2009/0075196 A1
(43) Pub. Date: Mar. 19, 2009

(54) TONER, ELECTROSTATIC LATENT IMAGE DEVELOPER, MAGNETIC LATENT IMAGE DEVELOPER, TONER CARTRIDGE, PROCESS CARTRIDGE, AND IMAGE FORMING APPARATUS

(75) Inventors: Takashi MATSUBARA, Kanagawa (JP); Kazunori Anazawa, Kanagawa (JP); Yuka Ito, Kanagawa (JP); Minquan Tian, Kanagawa (JP); Shinji Hasegawa, Kanagawa (JP); Kazuhiko Hirokawa, Kanagawa (JP); Makoto Furuki, Minamiashigara-shi (JP); Kazunaga Horiuchi, Tokyo (JP); Tomoko Miyahara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/053,434

(22) Filed: Mar. 21, 2008

(30) Foreign Application Priority Data
Sep. 13, 2007 (JP) 2007-238361

(51) Int. Cl. G03G 9/00; G03G 15/09; G03G 21/16

(52) U.S. Cl. 430/110.1; 399/277; 399/111

(57) ABSTRACT

The present invention provides a toner including a binder resin and metal particles containing Au, Ag, Cu, Pt, or an alloy thereof having a volume average particle diameter of from about 1 nm to about 300 nm, or an average maximum length of from about 10 nm to about 200 nm. The invention also provides a novel toner including metal particles which absorb light at plasmon frequencies.

### CROSS-REFERENCE TO RELATED APPLICATION

This application claims priority under 35USC 119 from Japanese Patent Application No. 2007-238361, filed Sep. 13, 2007.

### BACKGROUND

1. Technical Field

The present invention relates to a toner, an electrostatic latent image developer, a magnetic latent image developer, a toner cartridge, a process cartridge, and an image forming apparatus.

2. Related Art

Metal particles ranging from several nanometers to several tens of nanometers selectively absorb light at plasmon frequencies, and are increasingly used as colorants utilizing their optical properties. In the present description, metal particles absorbing light at plasmon frequencies may be referred to as “optical plasmon resonance particles”

### SUMMARY

According to an aspect of the invention, there is provided a toner including a binder resin and metal particles containing Au, Ag, Cu, Pt, or an alloy thereof having a volume average particle diameter of from about 1 nm to about 300 nm, or an average maximum length of from about 10 nm to about 200 nm.

### BRIEF DESCRIPTION OF THE DRAWINGS

Exemplary embodiments of the present invention will be described in detail based on the following figures, wherein:

FIG. 1 is a schematic configurational view showing a full color image forming apparatus of train-of-four tandem type;

FIG. 2 is a schematic configurational view showing an example of the process cartridge according to an exemplary embodiment of the invention;

FIG. 3 is a schematic configurational view showing a preferable example of the essential part of the image forming apparatus which forms images using the magnetic latent image developer according to an exemplary embodiment of the invention;

FIG. 4 is a TEM photograph of optical plasmon resonance particles 1;

FIG. 5 is a TEM photograph of optical plasmon resonance particles 2; and

FIG. 6 is a TEM photograph of optical plasmon resonance particles 3.

### DETAILED DESCRIPTION

The exemplary embodiments of the toner, electrostatic latent image developer, magnetic latent image developer, toner cartridge, process cartridge, and image forming apparatus according to the invention are described below in detail.

(Toner)

The toner according to an exemplary embodiment of the invention includes a binder resin and metal particles containing Au, Ag, Cu, Pt, or an alloy thereof having a volume average particle diameter of from about 1 nm to about 300 nm, or an average maximum length of from about 10 nm to about 200 nm (hereinafter may be referred to as optical plasmon resonance particles according to an exemplary embodiment of the invention).

The toner according to an exemplary embodiment of the invention has a high color forming density, and offers high density images under an electrophotographic system or magnetic imaging system even though the deposited amount of the toner per unit area is small. The reason is that the optical plasmon resonance particles according to an exemplary embodiment of the invention have a higher absorbance per unit volume than conventional known coloring agents such as organic or inorganic pigments, and offers a higher color forming density (image density) in a smaller amount in comparison with conventional known coloring agents.

The components of the toner according to an exemplary embodiment of the invention are described below. The toner according to an exemplary embodiment of the invention includes a binder resin and the optical plasmon resonance particles according to an exemplary embodiment of the invention, and may include other components as necessary.

(Optical Plasmon Resonance Particles According to an Exemplary Embodiment of the Invention)

The optical plasmon resonance particles according to an exemplary embodiment of the invention are metal particles containing Au, Ag, Cu, Pt, or an alloy thereof. The shape of the metal particles may be generally spherical having a volume average particle diameter of from about 1 nm to about 300 nm, or rod or disk such as circular or triangular one having an average maximum length of from about 10 nm to about 200 nm.

In the invention, the volume average particle diameter of the optical plasmon resonance particles is the average value of a diameter of a sphere having the same volume as the estimated volume of the sphere, cylindrical column, or polyangular column proximate to the particle shape observed by, for example, TEM or SEM.

In the invention, the maximum length of the optical plasmon resonance particles is the length of a rod-shaped metal particle in the longitudinal direction, or the diameter of a disk surface of a disk-shaped metal particle. In the invention, the average maximum diameter of the optical plasmon resonance particles is estimated on the basis of observation of the particle shape by, for example, TEM or SEM.

In the case of the optical plasmon resonance particles according to an exemplary embodiment of the invention are generally spherical metal particles, the volume average particle diameter thereof is preferably from about 5 nm to about 100 nm. In the case where the optical plasmon resonance particles according to an exemplary embodiment of the invention are disk-shaped metal particles, the average maximum length thereof is preferably from about 20 nm to about 100 nm.

The optical plasmon resonance particles according to an exemplary embodiment of the invention form various colors because the absorption wavelength thereof varies depending on, for example, the type, shape, and size (volume average particle diameter or average maximum length) of the metal contained in the particles. For example, in the case of the metal particles contain Au, those having a particle diameter of about 15 nm form a red color, and those having a particle diameter of 45 nm form a blue color. If the type, shape, and size of the metal particles are outside the above-described ranges, the metal particles may fail to serve as a coloring agent because of difficulty in color formation through plasmon absorption.

In the case where a full color image is formed using the toner according to an exemplary embodiment of the invention under an electrophotographic system or magnetic imaging system, yellow, magenta, and cyan toners are used.

In the case where the toner according to an exemplary embodiment of the invention is used as the yellow toner, the optical plasmon resonance particles may be generally triangular silver particles having a thickness of from about 8 nm to about 12 nm, and a side length of from about 30 nm to about 40 nm. In the case where the toner according to an exemplary embodiment of the invention is used as the magenta toner, the optical plasmon resonance particles may be generally triangular silver particles having a thickness of from about 8 nm to about 12 nm, and a side length of from about 50 nm to about 70 nm. In the case where the toner according to an exemplary embodiment of the invention is used as the cyan toner, the optical plasmon resonance particles may be generally triangular silver particles having a thickness of from about 8 nm to about 12 nm, and a side length of from about 80 nm to about 100 nm.

The method for producing the optical plasmon resonance particles according to an exemplary embodiment of the invention is not particularly limited, and examples thereof include reduction of a metal salt such as a silver salt in an organic solvent such as alkylamine, as described in Japanese Patent Application Laid-Open (JP-A) Nos. 2004-027347 and 2005-036309. The method for producing the rod-shaped metal particles may be the method described in, for example, “Design and applied technology of plasmon nanomaterials”, Chapter 4, CMC Inc. The method for producing the disk-shaped metal particles may be the method described in, for example, Nature, 2003, Vol. 425, p. 487.

When the optical plasmon resonance particles move closer to each other, they may interact each other to significantly change in their absorption spectrum. The phenomenon becomes more pronounced when the distance between the particles is about 50 nm or less. Therefore, the distance between the particles is preferably kept at about 50 nm or more.

On this account, it is preferable that the surface of the optical plasmon resonance particles to be coated with an oxide such as silica in a certain thickness thereby preventing the deterioration of the chroma and color forming properties caused by aggregation of the optical plasmon resonance particles during the toner production process. The thickness of the oxide coating is preferably from about 3 nm to about 300 nm, more preferably from about 5 nm to about 100 nm.

As the oxide to coat the optical plasmon resonance particles, an oxide that transparent to visible light is used. Examples of the transparent oxide include silica (SiO₂), aluminum oxide (Al₂O₃), cerium oxide (Ce₂O₃), indium oxide (In₂O₃), lanthanum oxide (La₂O₃), tin oxide (SnO₂), tantalum oxide (Ta₂O₅), zinc oxide (ZnO₂), titanium oxide (TiO₂), yttrium oxide (Y₂O₃), zirconium oxide (ZrO₂), tin (Sn)-doped indium oxide, antimony (Sb)-doped tin oxide, and aluminum (Al)-doped tin oxide.

The method for coating the optical plasmon resonance particles with the aforementioned oxide is not particularly limited, and may be, for example, the method described in JP-A No. 2001-288467, paragraphs 0025 to 0029.

However, optical plasmon resonance particles coated with an oxide having a particle diameter of, in particular, about 50 nm or more, the whole particle size exceeds about 100 nm, which may result in an increase in color murkiness due to scattering. The deterioration of the chroma due to scattering may be reduced by selecting a combination of the oxide and the binder resin such that the difference (Δn) in the refractive index of the oxide for coating and the below-described binder resin is Δn≦0.2. In the invention, the refractive index is measured using a spectroscopic ellipsometer.

The volume average particle diameter or the average maximum length of the optical plasmon resonance particles coated with the oxide is the size of the optical plasmon resonance particles excluding the thickness of the oxide coating.

The content of the optical plasmon resonance particles according to an exemplary embodiment of the invention in the toner according to an exemplary embodiment of the invention is preferably from about 1% by mass to about 50% by mass, more preferably from about 5% by mass to about 40% by mass, and particularly preferably from about 10% by mass to about 30% by mass with reference to the total toner mass. The content of a coloring agent such as a known organic pigment or inorganic pigment is usually 3% by mass to about 10% by mass with reference to the total toner mass.

The content of the optical plasmon resonance particles according to an exemplary embodiment of the invention in the toner according to an exemplary embodiment of the invention is preferably from about 1% by volume to about 20% by volume, more preferably from about 1% by volume to about 15% by volume, and particularly preferably from about 1% by volume to about 10% by volume with reference to the total toner volume. The content of a coloring agent such as a conventional known organic pigment or inorganic pigment is usually 5% by volume to about 10% by volume with reference to the total toner volume.

### (Binder Resin)

The binder resin included in the toner according to an exemplary embodiment of the invention is not particularly limited, and may be a crystalline or amorphous resin, or a mixture thereof.

The proportion of the crystalline and amorphous resins in the mixture may be appropriately selected so as to balance various properties such as low temperature fixing properties, antifogging properties, and image storage stability according to the intended use and purposes. In the mixture, generally the proportion of the crystalline resin to the whole binder resin is preferably from about 20% by mass to about 60% by mass. Alternatively, the binder toner may be produced to have a so-called core-shell structure composed of a core layer containing a crystalline resin, and a shell layer containing an amorphous resin and covering the core layer.

“Crystalline” of the crystalline resin composing the toner according to an exemplary embodiment of the invention refers to those not exhibiting a stepwise endothermic change but a sharp endothermic peak in differential scanning calorimetry (DSC), and specifically, the half width of the endothermic peak is within 10° C. as measured at a temperature rising rate of 10(° C./min). On the other hand, a resin having a half width of more than 10° C. or showing no sharp endothermic peak refers to an amorphous resin.

(Amorphous Resin)

The amorphous resin is not particularly limited, and may be known resin materials. Examples of the amorphous resin include homopolymers, heteropolymers, and mixtures thereof composed of: styrenes such as styrene, parachlorostyrene, and α-methylstyrene; vinyl group-containing esters such as methyl acrylate, ethyl acrylate, butyl acrylate, propyl acrylate, lauryl acrylate, ethylhexyl acrylate, methyl methacrylate, ethyl methacrylate, butyl methacrylate, propyl methacrylate, lauryl methacrylate, ethylhexyl methacrylate, vinyl acetate, and vinyl benzoate; double bond-containing carboxylic acids such as methyl maleate, ethyl maleate, and butyl maleate; olefins such as ethylene, propylene, butylene, and butadiene; double bond-containing carboxylic acids such as acrylic acid, methacrylic acid, and maleic acid.

Other examples include: non-vinyl condensed resins such as epoxy resins, polyester resins, polyurethane resins, polyamide resins, cellulose resins, and polyether resins; and mixtures of the non-vinyl condensed resins and the vinyl resins; and graft polymers obtained by polymerization of a vinyl monomer in the presence of the non-vinyl condensed resins.

In the invention, in order to control the degree of polymerization of the amorphous resin, a dissociative vinyl monomer may be added during polymerization of the monomer composing the amorphous resin. Examples of the dissociative vinyl monomer include monomers composing a polymer acid or polymer base, such as acrylic acid, methacrylic acid, maleic acid, cinnamic acid, fumaric acid, vinylsulfonic acid, ethyleneimine, vinylpyridine, and vinyl amine. Among them, carboxyl group-containing dissociative vinyl monomers such as acrylic acid, methacrylic acid, maleic acid, cinnamic acid, and fumaric acid are readily polymerizable and preferable from the viewpoint of the control of the degree of polymerization and glass transition temperature. The dissociative vinyl monomer may be copolymerized and used usually during polymerization of the amorphous resin.

When a vinyl monomer is used, a dispersion of the resin particles may be prepared through emulsion polymerization or seed polymerization using, for example, an ionic surfactant. When other resin is a oiliness and soluble in a solvent having relatively low water solubility is used, the dispersion of the resin particles is preferably prepared as follows: the resin is dissolved in the solvent, and an ionic surfactant and/or a polymer electrolyte is dissolved in water, and these solutions are treated together using, for example, a homogenizer thereby dispersing the particles in water. Thereafter, the solvent is evaporated by heating or decompression, and thus a dispersion of the resin particles is preferably prepared.

The weight average molecular weight (Mw) of the amorphous resin is preferably from about 10,000 to about 100,000, more preferably from about 20,000 to about 50,000, and even more preferably from about 20,000 to about 35,000. If the Mw is less than 10,000, plasticization tends to occur and occurrence of offset may not be prevented, and if more than 100,000, fixing may be failed under normal conditions.

The Mw is measured by gel permeation chromatography (GPC) under the following conditions. GPC is carried out using an apparatus (trade name: HLC-8120 GPC, SC-8020, manufactured by Tosoh Corporation), two columns (trade name: TSK gel, Super HM-H, manufactured by Tosoh Corporation, 6.0 mm ID×15 cm)″, and THF (tetrahydrofuran) as the eluent. As the measurement condition, the sample concentration is 0.5%, flow rate is 0.6 ml/min, sample injection amount is 10 μl, measurement temperature is 40° C., and the detector is an IR detector. The calibration curve is prepared using 10 polystylene standard samples (trade name: A-500, F-1, F-10, F-80, F-380, A-2500, F-4, F-40, F-128, and F-700, manufactured by Tosoh Corporation, TSK).

In an exemplary embodiment of the invention, a chain transferring agent may be used during polymerization of the amorphous resin. The chain transferring agent is not particularly limited, and may be a compound having a thiol component. Specifically, the chain transferring agent is preferably alkyl mercaptans such as hexyl mercaptan, heptyl mercaptan, octyl mercaptan, nonyl mercaptan, decyl mercaptan, or dodecyl mercaptan. The use of the chain transferring agent may narrow the molecular weight distribution of the amorphous resin, and thus improves the storage stability of the toner at high temperatures.

The amorphous resin may be produced by radical polymerization of a polymerizable monomer.

The initiator for the radical polymerization used herein is not particularly limited. Specific examples of the initiator include: peroxides such as hydrogen peroxide, acetyl preoxide, cumyl preoxide, tert-butyl peroxide, propionyl preoxide, benzoyl peroxide, chlorobenzoyl preoxide, dichlorobenzoyl preoxide, bromomethylbenzoyl peroxide, lauroyl preoxide, ammonium persulfate, sodium persulfate, potassium persulfate, diisopropyl peroxycarbonate, tetralin hydroperoxide, 1-phenyl-2-methylpropyl-1-hydroperoxide, pertriphenyl acetate tert-butylhydroperoxide, tert-butyl performate, tert-butyl peracetate, tert-butyl perbenzoate, tert-butyl perphenylacetate, tert-butyl permethoxyacetate, and tert-butyl per-N-(3-tolyl)carbaminate; azo compounds such as 2,2′-azobispropane, 2,2′-dichloro-2,2′-azobispropane, 1,1′-azo(methylethyl)diacetate, 2,2′-azobis(2-amidinopropane)hydrochloride, 2,2′-azobis(2-amidinopropane)nitrate, 2,2′-azobisisobutane, 2,2′-azobisisobutylamide, 2,2′-azobisisobutyronitrile, methyl 2,2′-azobis-2-methylpropionate, 2,2′-dichloro-2,2′-azobisbutane, 2,2′-azobis-2-methylbutyronitrile, dimethyl 2,2′-azobisisobutyrate, 1,1′-azobis(sodium 1-methylbutyronitrile-3-sulfonate), 2-(4-methylphenylazo)-2-methylmalonodinitrile, 4,4′-azobis-4-cyanovaleric acid, 3,5-dihydroxymethylphenylazo-2-methylmalonodinitrile, 2-(4-bromophenylazo)-2-allylmalonodinitrile, 2,2′-azobis-2-methyl valeronitrile, dimethyl 4,4′-azobis-4-cyanovalerate, 2,2′-azobis-2,4-dimethyl valeronitrile, 1,1′-azobiscyclohexane nitrile, 2,2′-azobis-2-propyl butyronitrile, 1,1′-azobis-1-chlorophenyl ethane, 1,1′-azobis-1-cyclohexane carbonitrile, 1,1′-azobis-1-cycloheptane nitrile, 1,1′-azobis-1-phenyl ethane, 1,1′-azobiscumene, ethyl 4-nitrophenylazobenzylcyanoacetate, phenyl azodiphenyl methane, phenyl azotriphenyl methane, 4-nitrophenyl azotriphenyl methane, 1,1′-azobis-1,2-diphenyl ethane, poly(bisphenol A-4,4′-azobis-4-cyanopentanoate), and poly(tetraethylene glycol-2,2′-azobisisobutyrate); 1,4-bis(pentaethylene)-2-tetrazene, and 1,4-dimethoxycarbonyl-1,4-diphenyl-2-tetrazene.

During the polymerization, the molecular weight control is mainly influenced by the amount of the polymerization initiator. The molecular weight usually increases as the amount of the polymerization initiator decreases.

The glass transition temperature of the amorphous resin is preferably from about 45° C. to about 60° C., more preferably from about 50° C. to about 60° C. If the glass transition temperature is lower than 45° C., the toner tends to cause blocking (aggregation of toner particles) during storage or in a developing device. On the other hand, if the glass transition temperature is higher than 60° C., the toner has an undesirably high fixing temperature.

In an exemplary embodiment of the invention, the glass transition temperature (Tg) is measured using a differential scanning calorimeter at a temperature rising rate of 3° C./min. The glass transition temperature refers to a temperature at a point of intersection of the extrapolated line of the base line and the rising line of the DSC curve in a region of the curve where an endothermic reaction occurs.

(Crystalline Resin)

The crystalline resin is not particularly limited as long as it is a resin having crystallinity, and specific examples thereof include crystalline polyester resins and crystalline vinyl resins. Of these, crystalline polyester resins are preferable from the viewpoints of fixability on paper, chargeability, and control of melting point in a desirable range during fixation, and in particular, crystalline linear aliphatic polyester resins having an appropriate melting point are more preferable.

A crystalline polyester resin is synthesized from an acid (dicarboxylic acid) component and an alcohol (diol) component. In the invention, a copolymer of a crystalline polyester containing other component at a ratio of 50% by mass or less with reference to the main chain of the polyester is also regarded as a crystalline polyester resin.

The method for producing the crystalline polyester resin is not particularly limited, and may be a common polyester polymerization method such as direct polycondensation or ester exchange wherein an acid component is reacted with an alcohol component. The method may be selected as appropriate according to the type of the monomer.

The crystalline polyester resin may be produced in a polymerization temperature range of from about 180° C. to about 230° C. As necessary, the reaction system is decompressed, and the reaction is proceeded while water and alcohol generated during condensation are removed. If the monomer is not soluble in or incompatible with the solvent at the reaction temperature, a high boiling point solvent may be added as solubilizing auxiliary agent to solubilize the monomer. The solubilizing solvent is removed by evaporation during the polycondensation reaction. If a poorly compatible monomer is present in a copolymerization reaction, it is preferable that the poorly compatible monomer be previously condensed with the acid or alcohol to be polycondensed with the monomer, and then the condensation product be polycondensed with the main component.

Examples of the catalyst which may be used for producing the crystalline polyester resin includes compounds of: alkali metals such as sodium and lithium; alkaline earth metals such as magnesium and calcium; metals such as zinc, manganese, antimony, titanium, tin, zirconium, and germanium; and phosphite compounds, phosphate compounds, and amine compounds.

Specific examples of the compounds include sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenylantimony, tributylantimony, tin formate, tin oxalate, tetraphenyltin, dibutyltin dichloride, dibutyltin oxide, diphenyltin oxide, zirconium tetrabutoxide, zirconium naphthenate, zirconyl carbonate, zirconyl acetate, zirconyl stearate, zirconyl octyate, germanium oxide, triphenyl phosphite, tris(2,4-t-butylphenyl) phosphite, ethyltriphenyl phosphonium bromide, triethylamine, and triphenylamine.

Specific examples of the crystalline polyester resin which may be used in an exemplary embodiment of the invention include poly-1,2-cyclopropenedimethylene isophthalate, polydecamethylene adipate, polydecamethylene azelate, polydecamethylene oxalate, polydecamethylene sebacate, polydecamethylene succinate, polyeicosamethylene malonate, polyethylene-p-(carbophenoxy)butylate, polyethylene-p-(carbophenoxy)undecanoate, polyethylene-p-phenylene diacetate, polyethylene sebacate, polyethylene succinate, polyhexamethylene carbonate, polyhexamethylene-p-(carbophenoxy)undecanoate, polyhexamethylene oxalate, polyhexamethylene sebacate, polyhexamethylene suberate, polyhexamethylene succinate, poly-4,4-isopropylidenediphenylene adipate, and poly-4,4-isopropylidene diphenylene malonate.

Other examples include trans-poly-4,4-isopropylidene diphenylene-1-methylcyclopropane dicarboxylate, polynonamethylene azelate, polynonamethylene terephthalate, polyoctamethylene dodecanedioate, polypentamethylene terephthalate, trans-poly-m-phenylene cyclopropan dicarboxylate, cis-poly-m-phenylenecyclopropane dicarboxylate, polytetramethylene carbonate, polytetramethylene-p-phenylene diacetate, polytetramethylene sebacate, polytrimethylene dodecanedioate, polytrimethylene octadecanedioate, polytrimethylene oxalate, polytrimethylene undecanedioate, poly-p-xyleneadipate, poly-p-xylene azelate, poly-p-xylene sebacate, polydiethyleneglycol terephthalate, cis-poly-1,4-(2-butene)sebacate, and polycaprolactone.

Other examples include copolymers of a plurality of ester monomers composing the above-described polymers, and copolymers and ester monomers with other monomers polymerizable with the ester monomers.

The melting point of the crystalline resin is preferably 40° C. or higher, more preferably 60° C. or higher. The upper limit is preferably 100° C. or lower, more preferably 90° C. or lower. In order to providing low temperature fixability, the melting point of the crystalline resin is preferably from about 60° C. to 95° C.

If the melting point of the crystalline resin is lower than 40° C., the toner may cause blocking during storage or use. On the other hand, if the melting point of the crystalline resin is higher than 100° C., the low temperature fixability may be not provided.

The melting point of the crystalline resin is measured using the above-described differential scanning calorimeter (DSC), and determined as the melting peak temperature in differential thermal analysis carried out at a temperature rising rate of 10° C./min from room temperature to 150° C. according to ASTM D3418-8. In the case where plurality of melting peaks are exhibited in the measurement, the maximum peak temperature is regarded as the melting point in the invention.

The molecular weight of the crystalline resin is not particularly limited, however the weight average molecular weight (Mw) is preferably from about 8,000 to about 80,000, more preferably from about 10,000 to about 50,000, and even more preferably from about 15,000 to about 30,000. If the weight average molecular weight of the crystalline resin is less than 8,000, the fixed image may have an insufficient strength, or the resin may be crushed during stirring in a developing device. On the other hand, if the weight average molecular weight of the crystalline resin is more than 80,000, the fixing temperature may be increased.

The molecular weight may be measured by the same method as that for measuring the molecular weight of the amorphous resin.

In the toner according to an exemplary embodiment of the invention, it is preferable that the amorphous resin and the crystalline resin be moderately compatible. If the amorphous resin and the crystalline resin are completely compatible, the toner viscosity may excessively decreases to deteriorate the hot offset resistance. On the other hand, if these resins are incompatible, the crystalline resin will not be incorporated into the toner however rejected by the surface, which may adversely affect the charging, powder, and fixing properties of the toner.

(Other Components)

As necessary, the toner according to an exemplary embodiment of the invention may contain other components in addition to a binder resin and the optical plasmon resonance particles according to an exemplary embodiment of the invention.

1) Coloring Agent

In an exemplary embodiment of the invention, the optical plasmon resonance particles serve as a coloring agent. In order to control the color tone of the toner image, other known coloring agent may be used together.

The coloring agent may be a known organic or inorganic pigment, a dye, or an oil-soluble dye.

Examples of the coloring agent include C. I. Pigment Red 48:1, C. I. Pigment Red 57:1, C. I. Pigment Red 122, C. I. Pigment Yellow 17, C. I. Pigment Yellow 97, C. I. Pigment Yellow 12, C. I. Pigment Yellow 180, C. I. Pigment Yellow 185, C. I. Pigment Blue 15:1, C. I. Pigment Blue 15:3, Lamp Black (C. I. No. 77266), Rose Bengal (C. I. No. 45432), Carbon Black, Nigrosin Dye (C. I. No. 50415B), metal complex salt dyes, metal complex salt dyes, and derivatives and mixtures thereof.

Other examples include various metal oxides such as silica, aluminum oxide, magnetite, various ferrites, cupric oxide, nickel oxide, zinc oxide, zirconium oxide, titanium oxide, and magnesium oxide, and mixtures thereof. The coloring agent to be used is selected from the viewpoints of hue angle, color saturation, brightness, weather resistance, OHP transparency, and dispersibility in the toner.

The coloring agents are dispersed by a known method. For example, a media disperser such as a rotary shearing homogenizer, a ball mill, a sand mill, or an attritor, and a high pressure counter jet disperser are favorably used for dispersion.

In the case where the coloring agent is subjected to emulsion aggregation, the coloring agent is dispersed in an aqueous system by the homogenizer in the presence of a polar surfactant.

2) External Additive

In an exemplary embodiment of the invention, the toner preferably includes an external additive thereby improving its transferability, removability, charge controllability, and in particular flowability. The external additive refers to inorganic particles attached to the toner surface.

Examples of the inorganic particles include SiO₂, TiO₂, Ti(OH)₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ (wherein n represents an integral number of 1 to 4), Al₂O₃.2SiO₂, CaCO₃, MgCO₃, BaSO₄, and MgSO₄. Among them, silica particles and titania particles are particularly preferably because they provide good flowability.

The volume average particle diameter of the external additive is preferably from about 5 nm to about 40 nm.

The volume average particle diameter of the external additive may be determined as follows. The particle size distribution of the external additive is measured using a laser diffraction particle size analyzer (for example, LA-700 manufactured by Horiba, Ltd.), the distribution is divided into particle size ranges (channels), and a cumulative distribution curve in terms of volume is subtracted from the side of smaller particles in the particle size distribution. On the curve, the particle size giving a particle accumulation of 50% is defined as a volume average particle size D₅₀ᵥ.

The surface of the inorganic particles of the external additive is preferably hydrophobized in advance. The hydrophobic treatment improves the powder flowability of the toner, reduces the environment dependence of charges, and prevents contamination of the carrier. The hydrophobic treatment may be carried out by, for example, immersing the inorganic particles in a hydrophobizing agent. The hydrophobizing agent is not particularly limited, and examples thereof include silane coupling agent, silicone oil, titanate coupling agents, and aluminum coupling agents. These agents may be used alone, or in combination of two or more of them. Among them, silane coupling agents are preferable.

3) Releasing Agent

Specific examples of the releasing agent include as follows.

Examples of waxes includes vegetal wax such as carnauba wax, cotton wax, Japan wax, and rice wax; animal wax such as yellow beeswax and lanoline; mineral wax such as ozokerite and ceresin; petroleum wax such as paraffin, microcrystalline, and petrolatum. In addition to these natural wax, synthetic wax is also usable, and examples thereof include: synthetic hydrocarbon wax such as Fischer-Tropsch wax and polyethylene wax; and fatty acid amides, esters, ketones, and ethers such as 12-hydroxystearic acid amide, stearic acid amide, phthalic anhydride imide, and chlorinated hydrocarbon.

Other examples of the releasing agent include crystalline polymers having a long alkyl group in the side chain thereof, for example, homopolymers of polyacrylates such as poly-n-stearyl methacrylate and poly-n-lauryl methacrylate, and copolymers thereof such as a n-stearyl acrylate/ethyl methacrylate copolymer. Among them, petroleum wax such as paraffin wax and microcrystalline wax, and synthetic wax are more preferable.

The content of the releasing agent is preferably from about 10% by mass to about 40% by mass, more preferably from about 10% by mass to about 30% by mass, even more preferably from about 15% by mass to about 30% by mass, and particularly preferably from about 15% by mass to about 25% by mass with reference to the whole toner. When the content of the releasing agent is more than 10% by mass or more, sufficient releasability is ensured, and the occurrence of hot offset is prevented. On the other hand, when the content is less than 40% by mass, the releasing agent will not be exposed at the toner surface, and provides good flowability and chargeability.

In addition, the toner according to an exemplary embodiment of the invention may be added a lubricant and/or a charge control agent as necessary.

Examples of the lubricant include fatty acid amides such as ethylenebisstearyl acid amide and oleic acid amide, and fatty acid metal salts such as zinc stearate and calcium stearate.

The charge control agent is added in order to improve and stabilize the chargeability, and examples thereof include various kinds of commonly used charge control agents such as quaternary ammonium salt compounds, nigrosin compounds, dyes composed of aluminum, iron, and chromium complexes, and triphenylmethane pigments. In the case where the toner is produced by the below-described emulsion aggregation method, in the aggregation process or the fusion/coalescence process, the charge control agent is preferably poorly soluble in water from the viewpoints of the control of the ionic strength influential on the stability of the aggregated particles, and the reduction of effluent contamination.

In particular, the charge control agent is preferably a compound or combination of compounds selected from the group consisting of metal salts of benzoic acid, metal salts of salicylic acid, metal salts of alkylsalicylic acid, metal salts of catechol, metal-containing bisazo dyes, tetraphenyl borate derivatives, quaternary ammonium salts, and alkylpyridinium salts. These compounds are commonly used for making powder toner.

In the case where inorganic particles are added to the toner by a wet process in order to control the charge, the inorganic particles may be any inorganic particles commonly used as external additives for toner surfaces, and examples thereof include silica, alumina, titania, calcium carbonate, magnesium carbonate, and tricalcium phosphate. In this case, the inorganic particles may be dispersed in the solvent using an ionic surfactant, polymer acid, or polymer base.

The toner according to an exemplary embodiment of the invention may have a core/shell structure. The binder resin composing the core is not particularly limited, and may be the crystalline resin, amorphous resin, or a mixture thereof. The binder resin composing the shell is also not particularly limited, however preferably the amorphous resin. The amorphous resins composing the core and shell may be the same or different from each other.

(Magnetic Substance)

In the case where the toner according to an exemplary embodiment of the invention is used under a magnetic imaging system (magnetography), the toner according to an exemplary embodiment of the invention includes a magnetic substance. The magnetic substance is preferably, for example, magnetite or ferrite expressed by MO.Fe₂O₃ or M.Fe₂O₄. In the formula, M is a divalent or monovalent metal ion such as Mn, Fe, Ni, Co, Cu, Mg, Zn, Cd, or Li, wherein the metals may be used alone or in combination of a plurality of them. Examples of the magnetic substance include iron oxides such as magnetite, γ-iron oxide, Mn—Zn ferrite, Ni—Zn ferrite, Mn—Mg ferrite, Li ferrite, and Cu—Zn ferrite. Among them, magnetite is more preferable due to its low cost.

Other examples of the metal oxide include yttrium iron garnet.

The average primary particle diameter of the magnetic substance is preferably from about 0.02 μm to about 2.0 μm. If the average primary particle diameter of the magnetic substance is without the range, the magnetic substance tends to aggregate, which may result in the failure of uniform dispersion into the binder resin.

The content of the magnetic substance varies depending on the intended magnetic force, and preferably from about 2% by mass to about 50% by mass, more preferably from about 4% by mass to about 30% by mass, with reference to the whole toner. When the content is within the range, sufficient magnetic force is provided.

Since usual magnetic substances assume a black color, the color attributable to magnetic substances (black color) must be masked when the magnetic substance is contained in a color toner such as a yellow, magenta, or cyan toner. The optical plasmon resonance particles according to an exemplary embodiment of the invention have higher absorbance per unit volume in comparison with conventional known coloring agents such as organic pigments or inorganic pigments, so that they are effective for masking the color of the magnetic substance.

The volume average particle diameter of the toner according to an exemplary embodiment of the invention is not particularly limited, however preferably from about 1 μm to about 5 μm, more preferably from about 1 μm to about 3 μm. In the case where the toner according to an exemplary embodiment of the invention is used under a magnetic imaging system (magnetography), the volume average particle diameter of the toner is preferably from about 1 μm to about 3 μm, more preferably from about 1 μm to about 2 μm. The volume average particle diameter of the toner is measured by the same method as that used for the external additive.

(Toner Production Method)

The method for producing the toner is not particularly limited, and may be, for example, a kneading pulverizing method, a suspension polymerization method, a solution suspension method, or an emulsion aggregation method. In order to produce a toner having a preferable shape factor and particle diameter, a wet granulation method is preferable. Examples of the wet granulation method include known methods such as a fusion suspension method, an emulsion aggregation method, and a dissolution suspension method. Among them, the emulsion aggregation method is preferable in the invention.

The kneading pulverizing method includes steps of kneading a binder resin, the optical plasmon resonance particles according to an exemplary embodiment of the invention, and other additive, crushing the mixture, and then classifying the crushed product. The particles prepared by the kneading pulverizing method have a relatively wide particle size distribution and an indefinite shape. It is preferable that the particles prepared by the kneading pulverizing method be subjected to classification thereby narrowing the particle size distribution, and then heat treatment thereby forming a spherical shape.

In the invention, the kneading pulverizing method may be appropriately carried out by a known method. The classification may appropriately use, for example, a gravity classifier, centrifugal classifier, inertial classifier, or sorting with a sieve. The heat treatment may use, for example, a fluidized bed, or a spray dryer.

The suspension polymerization method includes steps of suspending a solution containing a polymerizable monomer for making a binder resin, the optical plasmon resonance particles according to an exemplary embodiment of the invention, and other additive in an aqueous solvent, and then carrying out polymerization.

The solution suspension method includes steps of suspending a solution containing a binder resin, the optical plasmon resonance particles according to an exemplary embodiment of the invention, and other additive in an aqueous solvent, and then carrying out granulation.

The emulsion aggregation method includes steps of mixing a dispersion of resin particles, which is prepared by, for example, emulsion polymerization, with a coloring agent dispersion, which is prepared by dispersing the optical plasmon resonance particles according to an exemplary embodiment of the invention in a solvent, forming an aggregate corresponding to the toner particle diameter, and then heating the aggregate to cause fusion and coalescence thereby making a toner. More specifically, the emulsion aggregation method is superior to the kneading pulverizing method in easiness of the production of small-diameter toner particles with a narrow size distribution, and the surface smoothness and sphericity of the toner may be provided by controlling fusion coalescence conditions in the solution.

(Electrostatic Latent Image Developer)

The electrostatic latent image developer according to an exemplary embodiment of the invention includes the toner according to an exemplary embodiment of the invention. When the toner according to an exemplary embodiment of the invention is used alone, a one-component electrostatic latent image developer is prepared, and when combined with a carrier, a two-component electrostatic latent image developer is prepared. The electrostatic latent image developer according to an exemplary embodiment of the invention is preferably a two-component electrostatic latent image developer.

The carrier used in an exemplary embodiment of the invention is not particularly defined. Examples of the core material of the carrier include magnetic metals such as iron, steel, nickel, and cobalt, alloys of these metals with manganese, chromium, or rare earth metals, and magnetic oxides such as ferrite and magnetite. From the viewpoints of the surface properties and resistance of the core material, the core material is preferably an alloy containing ferrite, particularly manganese, lithium, strontium, or magnesium.

The carrier used in an exemplary embodiment of the invention is preferably composed of a core material whose surface is coated with a resin. The resin is not particularly limited as long as it serves as a matrix resin, and may be selected according to the intended use. Examples of the resin include known resins such as: polyolefin resins such as polyethylene and polypropylene; polyvinyl resins and polyvinylidene resins such as polystyrene, acrylic resins, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers; styrene-acrylate copolymers; straight silicone resins containing an organosiloxane bond and modifications thereof, fluorine resins such as polytetrafluoroethylene, polyvinyl fluoride, polyvinylidene fluoride, and polychlorotrifluoroethylene; silicone resins; polyesters; polyurethanes; polycarbonates; phenolic resins; amino resins such as urea-formaldehyde resins, melamine resin, benzoguanamine resin, urea resins, and polyamide resins; and epoxy resins. These resins may be used alone or in combination of two or more of them. In an exemplary embodiment of the invention, among these resins, at least a fluorine resin and/or a silicone resin is preferably used. The use of the fluorine resin and/or silicone resin is highly effective in preventing the contamination of the carrier (impaction) by the toner or external additive.

In the resin coating, resin particles and/or conductive particles may be dispersed. Examples of the resin particles include thermoplastic resin particles and heat curable resin particles. Among them, heat curable resin particles are preferable from the viewpoint of relative easiness of achieving high hardness, and nitrogen-containing resin particles are preferable from the viewpoint of imparting a negative charge to the toner. These resin particles may be used alone or in combination of two or more of them. The average particle diameter of the resin particles is preferably from about 0.1 μm to about 2 μm, more preferably from about 0.2 μm to about 1 μm. When the average particle diameter of the resin particles is 0.1 μm or more, the resin particles are favorably dispersed in the coating, and when 2 μm, the resin particles are hard to drop from the coating.

Examples of the conductive particles include: metal particles such as gold, silver, and copper; semi-conductive oxide particles such as carbon black, titanium oxide, and zinc oxide; and powders such as titanium oxide, zinc oxide, barium sulfate, aluminum borate, potassium titanate whose surfaces are coated with, for example, tin oxide, carbon black, or a metal. These particles may be used alone or in combination of two or more of them. Among them, carbon black particles are preferable from the viewpoint of production stability, cost, and conductivity. The type of the carbon black is not particularly limited, however carbon black having a DBP oil absorption of from about 50 ml/100 g to about 250 ml/100 g is preferable because it provides excellent production stability.

The method for forming the coating is not particularly limited. For example, a coating forming solution may be used, the solution containing cross-linking resin particles as the resin particles, and/or the conductive particles, and a matrix resin such as a styrene acrylic resin, a fluorine resin, or a silicone resin.

Specific examples of the method include an immersion method wherein the carrier core material is immersed into the coating forming solution, a spray method wherein a coating forming solution is sprayed over the carrier core material, and a kneader coater method wherein the carrier core material is mixed with the coating forming solution with the core material floated by flowing air, and then the solvent is removed.

The solvent used for the coating forming solution is not particularly limited as long as it selectively dissolves the resin as the matrix resin, and may be selected from known solvents. Examples of the solvent include: aromatic hydrocarbons such as toluene and xylene; ketones such as acetone and methyl ethyl ketone; and ethers such as tetrahydrofuran and dioxane.

(Magnetic Latent Image Developer)

The magnetic latent image developer according to an exemplary embodiment of the invention contains the magnetic substance-containing toner according to an exemplary embodiment of the invention, and a dispersion medium for dispersing the toner.

The dispersion medium is preferably water, or a mixture of water with a water-soluble organic solvent such as methanol or ethanol. Among them, water alone is particularly preferable. The content of the water-soluble organic solvent is preferably 30% by mass, more preferably 10% by mass with reference to the whole dispersion medium.

The production of the magnetic latent image developer may use various secondary materials which may be used for making common aqueous particle dispersions. Examples of the secondary materials include a dispersant, an emulsifying agent, a surfactant, a stabilizer, a wetting agent, a thickening agent, a foaming agent, a defoaming agent, a coagulant, a gelling agent, a sedimentation preventing agent, a charge control agent, an antistatic agent, an antiaging agent, a softening agent, a plasticizer, a filler, a coloring agent, a perfuming agent, an antisticking agent, and a releasing agent.

Specific examples of the surfactant include known surfactants such as anionic surfactants, nonionic surfactants, and cationic surfactants. Other examples of the surfactant include: silicone surfactants such as a polysiloxane oxyethylene adduct; fluorine surfactants such as perfluoroalkyl carboxylate, perfluoroalkyl sulfonate, and oxyethylene perfluoroalkyl ether; and biological surfactants such as spiculisporic acid and rhamnolipid, and lysolecithin.

The dispersant is effectively used as long as it is a polymer having a hydrophilic component and a hydrophobic component. Examples of the polymer include a styrene-styrenesulfonic acid copolymer, a styrene-maleic acid copolymer, a styrene-methacrylic acid copolymer, a styrene-acrylic acid copolymer, a vinyl naphthalene-maleic acid copolymer, a vinyl naphthalene-methacrylic acid copolymer, a vinyl naphthalene-acrylic acid copolymer, an alkyl acrylate ester-acrylate copolymer, an alkyl methacrylate ester-methacrylic acid copolymer, a styrene-alkyl methacrylate ester-methacrylic acid copolymer, a styrene-alkyl acrylate ester-acrylic acid copolymer, a styrene-methacrylic acid phenyl ester-methacrylic acid copolymer, and a styrene-methacrylic acid cyclohexyl ester-methacrylic acid copolymer. These copolymers may be any structures of random, block, or graft copolymers.

In an exemplary embodiment of the invention, a water-soluble organic solvent may be used in order to control the evaporation properties and interface properties. The water-soluble organic solvent is an organic solvent which will not be divided into two phases upon addition into water. Examples of the water-soluble organic solvent include monovalent or polyvalent alcohols, nitrogen-containing solvents, sulfur-containing solvents, and derivatives thereof.

In order to control the conductivity, pH, and other properties, the aqueous medium may additionally contain, for example, an alkali metal compound such as potassium hydroxide, sodium hydroxide, or hydroxide lithium, a nitrogen-containing compound such as ammonium hydroxide, triethanolamine, diethanolamine, ethanolamine, or 2-amino-2-methyl-1-propanol, an alkaline earth metal compound such as calcium hydroxide, an acid such as sulfuric acid, hydrochloric acid, or nitric acid, and a salt of a strong acid with a weak alkaline such as ammonium sulfate.

As necessary, for the purposes of, for example, mildewproof, preservation, or rust inhibition, other additives such as benzoic acid, dichlorophen, hexachlorophen, and sorbic acid may be added. Other examples of the additives include an antioxidant, a viscosity adjusting agent, a conductive agent, an ultraviolet absorber, and a chelating agent.

In an exemplary embodiment of the invention, the viscosity of the magnetic latent image developer is selected according to the image formation system, and is preferably from about 1 mPa·s to about 500 mPa·s. If the viscosity of the magnetic latent image developer is less than 1 mPa·s, the amount of the magnetic substance-containing toner according to an exemplary embodiment of the invention and the amount of additives are insufficient, which may result in an insufficient image density. On the other hand, if the viscosity of the magnetic latent image developer is more than 500 mPa·s, the excessively high viscosity may result in difficulty in handling and deterioration of developability.

(Image Forming Apparatus)

The image forming apparatus according to an exemplary embodiment of the invention using the electrostatic latent image developer according to an exemplary embodiment of the invention is described below.

The image forming apparatus according to an exemplary embodiment of the invention includes: an electrostatic latent image holding body; a charging unit for charging the surface of the electrostatic latent image holding member; an electrostatic latent image formation unit for forming an electrostatic latent image on the charged surface of the electrostatic latent image holding member; an image formation unit for developing the electrostatic latent image on the surface of the electrostatic latent image holding member using the electrostatic latent image developer according to an exemplary embodiment of the invention thereby forming a toner image; a transfer unit for transferring the toner image from the surface of the electrostatic latent image holding member to the surface of a transferred medium; a fixing unit for fixing the transferred toner image on the surface of the transferred medium; and a cleaning unit for removing residual toner from the surface of the electrostatic latent image holding member after the transfer.

In the image forming apparatus, for example, the portion containing the image formation unit may be a cartridge structure (process cartridge) which is detachably mounted on the main body of the image forming apparatus.

An example of the image forming apparatus according to an exemplary embodiment of the invention is illustrated below, however the apparatus is not limited to the example. The major portions shown in figures are described in detail, and explanation of other portions is omitted.

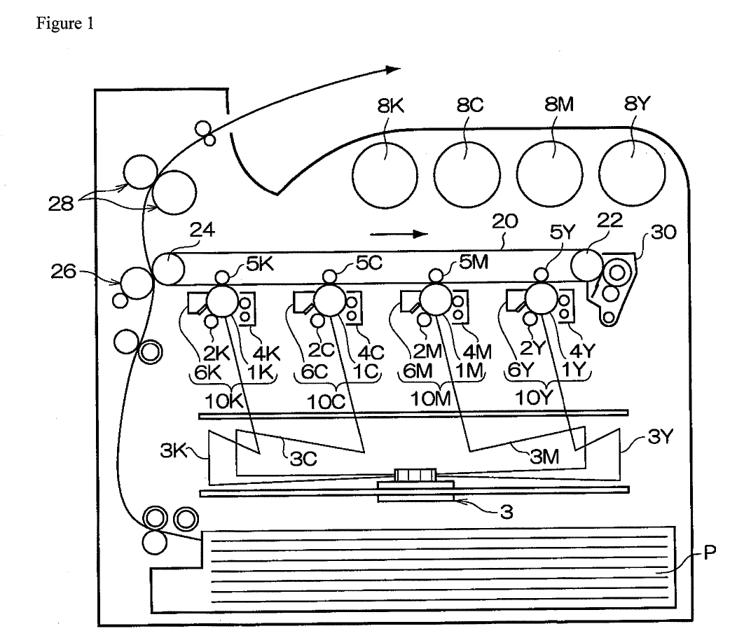

FIG. 1 is a schematic configurational view showing a full color image forming apparatus of train-of-four tandem type. The image forming apparatus shown in FIG. 1 includes first to fourth image formation units, 10Y, 10M, 10C, and 10K of an electrophotographic system for outputting yellow (Y), magenta (M), cyan (C), and black (K) images according to the color-separated image data. These image formation units (hereinafter referred to as “units”) 10Y, 10M, 10C, and 10K are arranged in parallel in the horizontal direction at established intervals. These units 10Y, 10M, 10C, and 10K may be process cartridges which are detachably mounted on the main body of the image forming apparatus.

In FIG. 1, above the units 10Y, 10M, 10C, and 10K, an intermediate transfer belt 20 as the intermediate transfer body is extended through the units. The intermediate transfer belt 20 is entrained around a driving roller 22 and a support roller 24, wherein the two rollers are arranged apart from each other in the horizontal direction, and the support roller 24 is in contact with the inner surface of the intermediate transfer belt 20. The intermediate transfer belt 20 runs in the direction from the first unit 10Y toward the fourth unit 10K. The support roller 24 is urged with a spring or the like (not shown) in a direction away from the driving roller 22 thereby giving a predetermined tension to the intermediate transfer belt 20 wound around them. The side of the intermediate transfer belt 20 having the image holding member includes an intermediate transfer body cleaning device 30 opposed to the driving roller 22.

The development devices (image formation units) 4Y, 4M, 4C, and 4K of the units 10Y, 10M, 10C, and 10K are capable of receiving yellow, magenta, cyan, and black toners from the toner cartridges 8Y, 8M, 8C, and 8K, respectively. At least one of the yellow, magenta, and cyan toners is the toner according to an exemplary embodiment of the invention.

The above-described first to fourth units 10Y, 10M, 10C, and 10K have the same structure, so that the first unit 10Y for forming an yellow image arranged on the upper reach of the running direction of the intermediate transfer belt is illustrated as a representative example. In the second to fourth units 10M, 10C, and 10K, components corresponding to those of the first unit 10Y are denoted by the same reference numerals with the yellow (Y) replaced by magenta (M), cyan (C), or black (K), and thus detailed description thereof is omitted.

The first unit 10Y includes a photoreceptor 1Y which serves as an electrostatic latent image holding member. Around the photoreceptor 1Y, a charging roller 2Y (charging unit) for charging the surface of the photoreceptor 1Y to a predetermined potential, an exposure device 3 (electrostatic latent image formation unit) for exposing the charged surface of the photoreceptor 1Y to a laser beam 3Y according to the color-separated image signals thereby forming an electrostatic latent image, a development device (image formation unit) 4Y for supplying a charged toner to the electrostatic latent image thereby developing an electrostatic latent image, a primary transfer roller 5Y (primary transfer unit) for transferring the toner image onto the intermediate transfer belt 20, and a photoreceptor cleaning device (cleaning unit) 6Y for removing the residual toner from the photoreceptor 1Y after the primary transfer.

The primary transfer roller 5Y is arranged inside the intermediate transfer belt 20 in a position opposed to the photoreceptor 1Y Each of the primary transfer rollers 5Y, 5M, 5C, and 5K is connected to a bias power supply (not shown) for applying a primary transfer bias. The bias power supply is controlled by a control unit (not shown), by which the transfer bias applied to each of the primary transfer rollers is varied.

The operation for forming an yellow image in the first unit 10Y is described below. Before the operation, the charging roller 2Y charges the surface of the photoreceptor 1Y to a potential of about −600 V to −800 V.

The photoreceptor 1Y is composed of a conductive substrate (volume resistivity at 20° C.: 1×10⁻⁶ Ωcm or less), and a photosensitive layer laminated on the substrate. The photosensitive layer has a high resistance (equivalent to the resistance of a common resin) under normal conditions, however once irradiated with the laser beam 3Y, its specific resistance changes in the areas irradiated with the laser beam. Then, the laser beam 3Y is outputted toward the charged surface of the photoreceptor 1Y through the exposure device 3 according to the yellow image data sent from a control unit (not shown). The surface of the photosensitive layer of the photoreceptor 1Y is irradiated with the laser beam 3Y so that an electrostatic latent image in the yellow printing pattern is formed on the surface of the photoreceptor 1Y.

The electrostatic latent image is an image formed on the surface of the photoreceptor 1Y by an electric charge, and is a so-called negative latent image formed as follows: the laser beam 3Y decreases the specific resistance of the irradiated areas on the photosensitive layer to dissipate the charge on the surface of the photoreceptor 1Y, while the areas not irradiated with the laser beam 3Y have a residual charge.

Thus, an electrostatic latent image is formed on the photoreceptor 1Y, and conveyed to a predetermined development position in synchronism with the rotation of the photoreceptor 1Y At the development position, the electrostatic latent image on the photoreceptor 1Y is developed to form a visible image (toner image) by a development device 4Y.

The development device 4Y contains an electrostatic latent image developer including an yellow toner and a carrier. The yellow toner is stirred in the development device 4Y to be triboelectrically charged to have the same polar charge (negative charge) as the charge on the photoreceptor 1Y, and held on a developer roll (developer retainer). Then, as the surface of the photoreceptor 1Y passes through the development device 4Y, the yellow toner electrostatically adheres to the discharged latent image on the surface of the photoreceptor 1Y, and thus an electrostatic latent image is developed by the yellow toner. The photoreceptor 1Y having the yellow toner image is continuously rotated at a predetermined speed, so that the toner image developed on the photoreceptor 1Y is conveyed to a predetermined primary transfer position.

Once the yellow toner image is conveyed from the photoreceptor 1Y to the primary transfer position, a predetermined primary transfer bias is applied to the primary transfer roller 5Y, so that an electrostatic force in the direction from the photoreceptor 1Y toward primary transfer roller 5Y is applied to the toner image, and thus the toner image on the photoreceptor 1Y is transferred onto the intermediate transfer belt 20. The applied transfer bias has a positive polarity inversely charged to the negative polarity of the toner. For example, the first unit 10Y is adjusted to about +10 μA by a control unit (not shown).

On the other hand, the residual toner on the photoreceptor 1Y is removed by a cleaning device 6Y, and then collected.

In the same manner, magenta, cyan, and black toner images are sequentially formed in a second unit 10M, a third unit 10C, and a fourth unit 10K, respectively. These toner images are superimposed on the intermediate transfer belt 20 to form a multiple toner image.

The intermediate transfer belt 20 having the multiple four-color toner image arrives at a secondary transfer portion which is formed by the intermediate transfer belt 20, the support roller 24 in contact with the inner surface of the intermediate transfer belt 20, and a secondary transfer roller (secondary transfer unit) 26 disposed at the image-bearing surface side of the intermediate transfer belt 20. A recording paper P (transferred medium) is fed at predetermined intervals by a feeding mechanism to the gap between the secondary transfer roller 26 and the intermediate transfer belt 20 which are pressed against each other under pressure, and a predetermined secondary transfer bias is applied to the support roller 24. The applied transfer bias has the same negative polarity as the polarity of the toner, and the electrostatic force in the direction from the intermediate transfer belt 20 toward the recording paper P is exerted on the toner image, so that the toner image is transferred from the intermediate transfer belt 20 onto the recording paper P. The secondary transfer bias is established according to the resistance detected by a resistance detector (not shown) which detects the resistance on the secondary transfer portion, and is controlled by voltage.

Subsequently, the recording paper P is sent to the fixing device (fixing unit) 28, and the toner image is heated, and the color-superimposed toner image is fused and fixed on the recording paper P. The recording paper P having the fixed color image is conveyed to the outlet, and thus a series of color image formation operations is completed.

In this image forming apparatus, the toner image is transferred to the recording paper P via the intermediate transfer belt 20. The image forming apparatus is not limited to the structure, and the toner image may be directly transferred from the photoreceptor to the recording paper.

(Process Cartridge and Toner Cartridge)

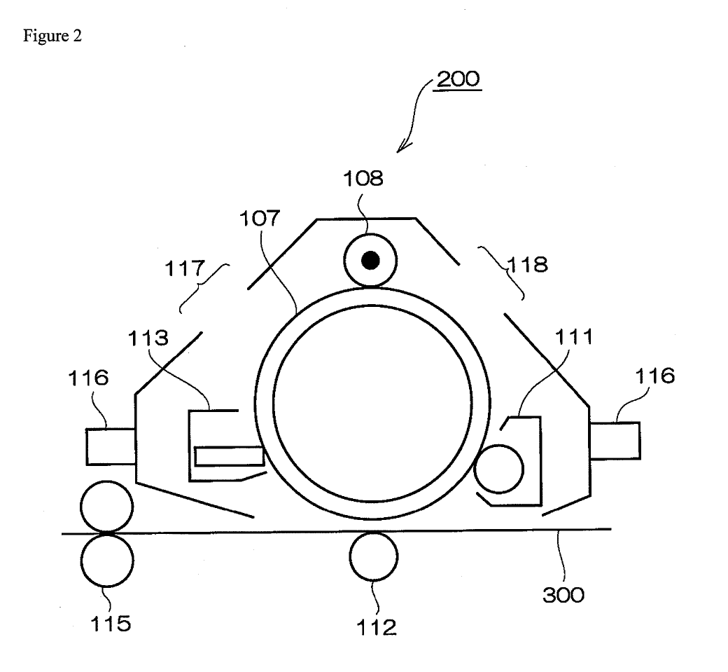

FIG. 2 is a schematic configurational view showing a preferable example of the process cartridge according to an exemplary embodiment of the invention which contains the electrostatic latent image developer according to an exemplary embodiment of the invention. The process cartridge 200 includes a photoreceptor 107, a charging device 108, a development device 111, a photoreceptor cleaning device (cleaning unit) 113, an opening 118 for exposure, and, an opening 117 for discharge-exposure, wherein these components are assembled and integrated by a fixing rail 116.

The process cartridge 200 is detachably mounted on the main body of an image forming apparatus including a transfer device 112, a fixing device 115, and other components (not shown), and forms the image forming apparatus together with the main body of the image forming apparatus. The reference numeral 300 denotes recording paper.

The process cartridge shown in FIG. 2 includes a photoreceptor 107, a charging device 108, a development device 111, a cleaning device 113, an opening 118 for exposure, and an opening 117 for discharge-exposure. These devices may be selectively combined.

The process cartridge according to an exemplary embodiment of the invention is detachably mounted on the main body of the image forming apparatus, and includes at least one selected from the group consisting of an image formation unit (development device 111), an electrostatic latent image holding member (photoreceptor 107), a charging unit (charging device 108) for charging the electrostatic latent image holding member, and a cleaning unit (cleaning device 113) for removing the residual toner from the surface of the electrostatic latent image holding member.

The toner cartridge according to an exemplary embodiment of the invention is illustrated below. The toner cartridge according to an exemplary embodiment of the invention is detachably mounted on the image forming apparatus, and contains the toner according to an exemplary embodiment of the invention to be supplied to the image formation unit provided within the image forming apparatus. The toner cartridge of the invention contains at least a toner, and may additionally contain, for example, a developer according to the mechanism of the image forming apparatus.

In the image forming apparatus shown in FIG. 1, the toner cartridges 8Y, 8M, 8C, and 8K are detachable, and each of the development devices 4Y, 4M, 4C, and 4K is connected to a toner cartridge corresponding to each development device (color) through a toner feed pipe (not shown). When the amount of the toner contained in the toner cartridge is running out, the toner cartridge may be replaced.

The image forming apparatus according to an exemplary embodiment of the invention using the magnetic latent image developer according to an exemplary embodiment of the invention is described below.

The image forming apparatus according to an exemplary embodiment of the invention includes a magnetic latent image holding member, a magnetic latent image formation unit for forming a magnetic latent image on the surface of the magnetic latent image holding member, a developer storage unit for storing the magnetic latent image developer according to an exemplary embodiment of the invention, a developer feeding unit for feeding the magnetic latent image developer to the surface of the magnetic latent image holding member having the magnetic latent image thereby developing the magnetic latent image into a toner image, a transfer unit for transferring the toner image to the surface of the transferred medium, and a demagnetizer for demagnetizing the magnetic latent image on the surface of the magnetic latent image holding member.

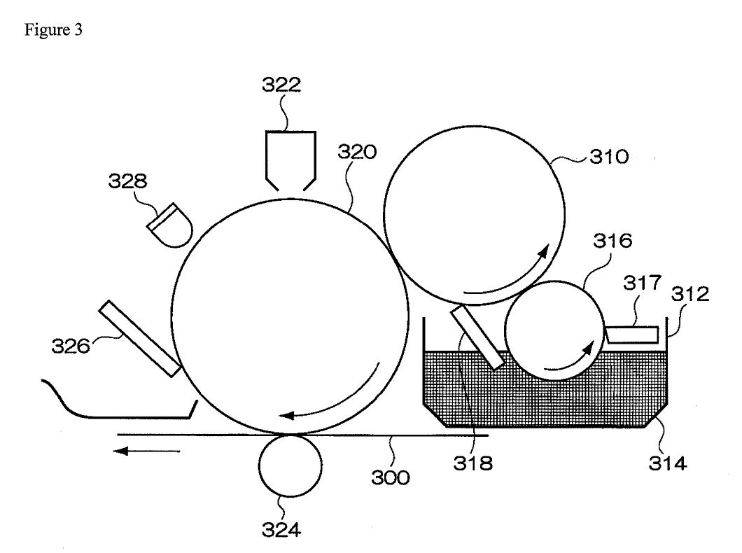

FIG. 3 is a schematic configurational view showing an example of the essential part of the image forming apparatus which forms images using the magnetic latent image developer according to an exemplary embodiment of the invention. As shown in FIG. 3, the image forming apparatus forms an image through the contact of a development roll 310 (developer feeding unit) having a magnetic latent image developer with a magnetic recording drum 320 which is a magnetic latent image holding member.

In the first place, a magnetic latent image is recorded on the magnetic recording drum 320, which is composed mainly of a Co—Ni magnetism plating, by a magnetic recording head 322, which is a magnetic latent image formation unit, according to image signals under a line scanning system.

Subsequently, the development roll 310 having the magnetic latent image developer is brought into contact with the magnetic recording drum 320, by which the magnetic latent image is developed into a toner image. The magnetic latent image developer is supplied to the development roll 310 by a developer applying roll 316, wherein a portion of the developer applying roll 316 contacts with and retains a magnetic latent image developer 314 stored in a storage tank 312 for storing the developer, and then other portion contacts with the development roll 310 thereby applying the magnetic latent image developer 314 to the roll. The amount of the developer retained by the developer application roll 316 is adjusted by a metering blade 317.

Subsequently, the toner image on the magnetic recording drum 320 is moved to the interface with a transfer roll 324 (transfer unit), simultaneously a recording medium 300 (transferred medium) is inserted into the nip portion between the energized transfer roll 324 and the magnetic recording drum 320, so that the toner image is transferred onto the recording medium 300. The transferred toner image is conveyed as it is, and pressurized and heated by a fixing device (not shown) to be fixed on the recording medium 300.

After the transfer, the residual toner on the magnetic recording drum 320 is removed by a blade 326, and the magnetic latent image on the surface of the magnetic recording drum 320 is erased by a demagnetizing head 328 (demagnetizer). The magnetic latent image developer remaining on the surface of the development roll 310 after development is scraped by a cleaning blade 318 in contact with the surface of the development roll 310, and collected into a storage tank 312.

In the image forming apparatus according to an exemplary embodiment of the invention, the magnetic latent image holding member (magnetic recording drum 320), the developer storage unit (storage tank 312) for storing the magnetic latent image developer according to an exemplary embodiment of the invention, and the developer feeding unit (development roll 310) for feeding a magnetic latent image developer to the surface of the magnetic latent image holding member having a magnetic latent image may be included in a process cartridge which is detachably mounted on the main body of the image forming apparatus.

The invention includes the following exemplary embodiments.

(1) A first embodiment is a toner containing a binder resin and metal particles containing Au, Ag, Cu, Pt, or an alloy thereof having a volume average particle diameter of 1 nm to about 300 nm, or an average maximum length of 10 nm to about 200 nm.

(2) A second embodiment is the toner of (1), wherein the metal particles are substantially triangular silver particles having a thickness of 8 nm to about 12 nm, and a side length of 30 nm to about 40 nm.

(3) A third embodiment is the toner of (1), wherein the metal particles are substantially triangular silver particles having a thickness of 8 nm to about 12 nm, and a side length of 50 nm to about 70 nm.

b 4) A fourth embodiment is the toner of (1), wherein the metal particles are substantially triangular silver particles having a thickness of 8 nm to about 12 nm, and a side length of 80 nm to about 100 nm.

(5) A fifth embodiment is the toner of (1), which has a volume average particle diameter of 1 μm to about 5 μm.

(6) A sixth embodiment is the toner of (2), which has a volume average particle diameter of 1 μm to about 5 μm.

(7) A seventh embodiment is the toner of (1), which further includes a magnetic substance, and has a volume average particle diameter of 1 μm to about 3 μm.

(8) An eighth embodiment is the toner of (2), which further includes a magnetic substance, and has a volume average particle diameter of 1 μm to about 3 μm.

(9) A ninth embodiment is an electrostatic latent image developer including the toner of (1).

(10) A tenth embodiment is an electrostatic latent image developer including the toner of (2).

(11) An eleventh embodiment is a magnetic latent image developer including the toner of (7) and a dispersion medium for dispersing the toner.

(12) A twelfth embodiment is a magnetic latent image developer including the toner of (8) and a dispersion medium for dispersing the toner.

(13) A thirteenth embodiment is an image forming apparatus including an electrostatic latent image holding member, a charging unit for charging the surface of the electrostatic latent image holding member, an electrostatic latent image formation unit for forming an electrostatic latent image on the charged surface of the electrostatic latent image holding member, an image formation unit for developing the electrostatic latent image formed on the surface of the electrostatic latent image holding member using the electrostatic latent image developer of (9) thereby forming a toner image, a transfer unit for transferring the toner image formed on the surface of the electrostatic latent image holding member to the surface of a transferred medium, a fixing unit for fixing the transferred toner image on the surface of the transferred medium, and a cleaning unit for removing residual toner from the surface of the electrostatic latent image holding member after the transfer.

(14) A fourteenth embodiment is a toner cartridge detachably mounted on an image forming apparatus, the toner cartridge containing the toner of (1) to be fed to an image formation unit provided in the image forming apparatus.

(15) A fifteenth embodiment is a toner cartridge detachably mounted on an image forming apparatus, the toner cartridge containing the toner of (2) to be fed to an image formation unit provided in the image forming apparatus.

(16) A sixteenth embodiment is a process cartridge containing the electrostatic latent image developer of (9), the process cartridge including at least one selected from the group consisting of an image formation unit for developing an electrostatic latent image formed on the surface of an electrostatic latent image holding member using the electrostatic latent image developer thereby forming a toner image, an electrostatic latent image holding member, a charging unit for charging the electrostatic latent image holding member, and a cleaning unit for removing residual toner from the surface of the electrostatic latent image holding member, and the process cartridge being detachably mounted on a main body of an image forming apparatus.

(17) An seventeenth embodiment is an image forming apparatus including a magnetic latent image holding member, a magnetic latent image formation unit for forming a magnetic latent image on the surface of the magnetic latent image holding member, a developer storage unit for storing the magnetic latent image developer of (11), a developer feeding unit for feeding the magnetic latent image developer to the surface of the magnetic latent image holding member having the magnetic latent image in order to develop the magnetic latent image into a toner image, a transfer unit for transferring the toner image to the surface of a transferred medium, and a demagnetizer for demagnetizing the magnetic latent image on the surface of the magnetic latent image holding member.

(18) An eighteenth embodiment is a process cartridge including a magnetic latent image holding member, a developer storage unit for storing the magnetic latent image developer of (11), and a developer feeding unit for feeding the magnetic latent image developer to the surface of the magnetic latent image holding member having the magnetic latent image, the process cartridge being detachably mounted on a main body of an image forming apparatus.

### EXAMPLES

The present invention is further illustrated with reference to the following examples, however the invention is not limited to the following examples. “Parts” and “%” represent “parts by mass” and “% by mass”, respectively, unless otherwise noted.

(Preparation of dispersion of Optical Plasmon Resonance Particles 1)

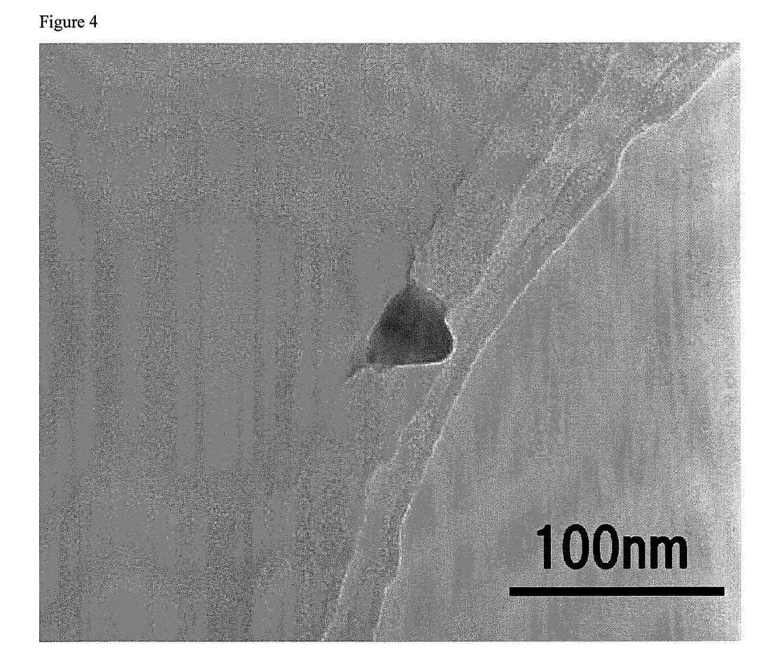

A dispersion of optical plasmon resonance particles exhibiting a yellow color is prepared by the following method. The obtained optical plasmon resonance particles 1 are generally triangular, and have a thickness of 9 nm and a side length of 35 nm. FIG. 4 shows a TEM photograph of the optical plasmon resonance particles 1 taken with H-9000 (manufactured by Hitachi, Ltd.) at an accelerating voltage of 200 kV at 100,000-fold magnification.

1 mL of 30 mM sodium citrate and 2 mL of 5 mM of silver nitrate are added to 95 mL of distilled water, and cooled on ice. With vigorous stirring at 800 rpm, 1 mL of 50 mM sodium borohydride is added to the solution at one time. Thereafter, with stirring, 5 drops of 50 mM sodium borohydride are added every 2 minutes over a period of 10 minutes. After a lapse of 10 minutes, 1 mL of 5 mM bis(p-sulfonatophenyl)phenylphosphine dehydrate dipottasium and 0.5 mL of 50 mM sodium borohydride are added, and the mixture is allowed to stand for 12 hours under stirring at 200 rpm kept away from light irradiation. Thus, a dispersion of silver fine particles having a diameter of about 4 nm is obtained. The dispersion is transferred to a vessel having mirror-finished surfaces, and beams having wavelengths of 340 nm (20 mW) and 435 nm (50 mW) are launched into the vessel for over 10 hours, whereby the triangular silver fine particles are obtained. Further, the obtained dispersion is centrifuged at 10,000 rpm for 30 minutes using a centrifugal machine (trade name: HIMAC SCR 20B, manufactured by Hitachi, Ltd.), the supernatant is removed, and thus a 0.5% dispersion is obtained. A 5% dispersion is obtained by carrying the centrifugation and supernatant removal in the same manner.

(Preparation of Dispersion of Optical Plasmon Resonance Particles 2)

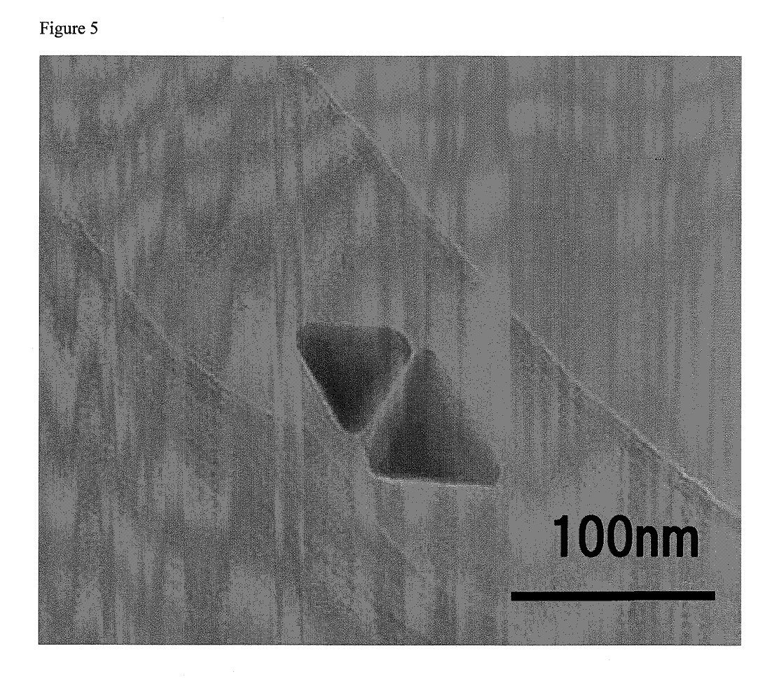

A dispersion of optical plasmon resonance particles exhibiting a magenta color is prepared by the following method. The obtained optical plasmon resonance particles 2 are generally triangular, and have a thickness of 9 nm and a side length of 50 nm. FIG. 5 shows a TEM photograph of the optical plasmon resonance particles 2 taken with H-9000 (manufactured by Hitachi, Ltd.) at an accelerating voltage of 200 kV at 100,000-fold magnification.

1 mL of 30 mM sodium citrate and 2 mL of 5 mM of silver nitrate are added to 95 mL of distilled water, and cooled on ice. With vigorous stirring at 800 rpm, 1 mL of 50 mM sodium borohydride is added to the solution at one time. Thereafter, with stirring, 5 drops of 50 mM sodium borohydride are added every 2 minutes over a period of 10 minutes. After a lapse of 10 minutes, 1 mL of 5 mM bis(p-sulfonatophenyl)phenylphosphine dehydrate dipottasium and 0.5 mL of 50 mM sodium borohydride are added, and the mixture is allowed to stand for 12 hours with stirring at 200 rpm kept away from light irradiation. Thus, a dispersion of silver fine particles having a diameter of about 4 nm is obtained. The dispersion is transferred to a vessel having mirror-finished surfaces, and the interior of the vessel is irradiated with beams having wavelengths of 340 nm (20 mW) and 490 nm (50 mW) for over 10 hours, whereby the triangular silver fine particles are obtained. Further, the obtained dispersion is centrifuged at 10,000 rpm for 30 minutes using a centrifugal machine (trade name: HIMAC SCR 20B, manufactured by Hitachi, Ltd.), the supernatant is removed, and thus a 0.5% dispersion is obtained. A 5% dispersion is obtained by carrying the centrifugation and supernatant removal in the same manner.

(Preparation of Dispersion of Optical Plasmon Resonance Particles 3)

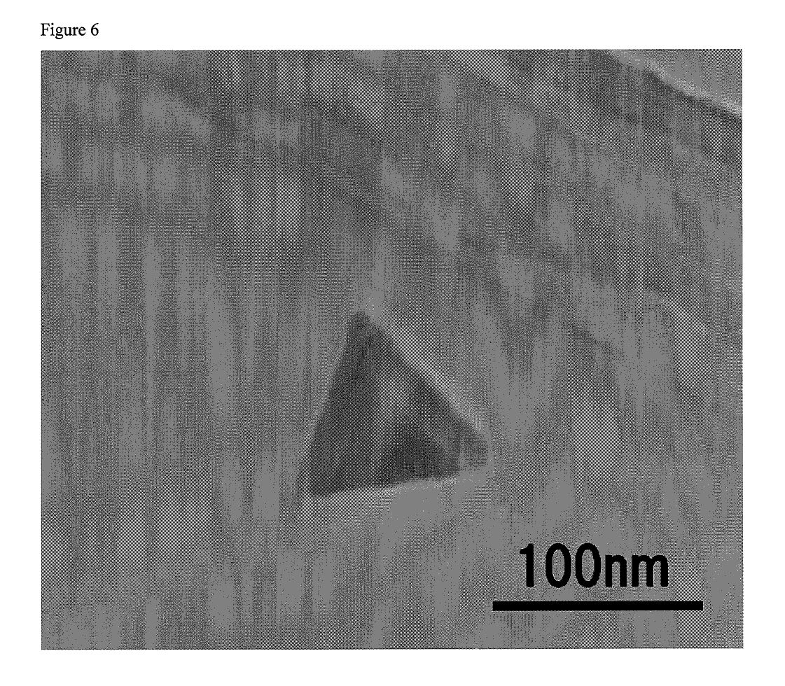

A dispersion of optical plasmon resonance particles exhibiting a cyan color is prepared by the following method. The obtained optical plasmon resonance particles 3 are generally triangular, and have a thickness of 9 nm and a side length of 70 nm. FIG. 6 shows a TEM photograph of the optical plasmon resonance particles 3 taken with H-9000 (manufactured by Hitachi, Ltd.) at an accelerating voltage of 200 kV under a magnification of 100,000×.

1 mL of 30 mM sodium citrate and 2 mL of 5 mM of silver nitrate are added to 95 mL of distilled water, and cooled on ice. Under vigorous stirring at 800 rpm, 1 mL of 50 mM sodium borohydride is added to the solution at one time. Thereafter, with stirring, 5 drops of 50 mM sodium borohydride are added every 2 minutes over a period of 10 minutes. After a lapse of 10 minutes, 1 mL of 5 mM bis(p-sulfonatophenyl)phenylphosphine dehydrate dipottasium and 0.5 mL of 50 mM sodium borohydride are added, and the mixture is allowed to stand for 12 hours under stirring at 200 rpm kept away from light irradiation. Thus, a dispersion of silver fine particles having a diameter of about 4 nm is obtained. The dispersion is transferred to a vessel having mirror-finished surfaces, and the interior of the vessel is irradiated with beams having wavelengths of 340 nm (20 mW) and 550 nm (50 mW) are launched into the vessel for over 10 hours, whereby the triangular silver fine particles are obtained. Further, the obtained dispersion is centrifuged at 10,000 rpm for 30 minutes using a centrifugal machine (trade name: HIMAC SCR 20B, manufactured by Hitachi, Ltd.), the supernatant is removed, and thus a 0.5% dispersion is obtained. A 5% dispersion is obtained by carrying the centrifugation and supernatant removal in the same manner.

(Preparation of Yellow Pigment Dispersion)

The following ingredients are mixed, dispersed with a homogenizer (ULTRA TURRAX T50, manufactured by IKA) and ultrasonic vibration, and thus an yellow pigment dispersion having a volume average particle diameter of 150 nm is obtained.

Yellow pigment C. I. Pigment Yellow 74 (manufactured by Dainichiseika Color & Chemicals Mfg. Co., Ltd.) 50 parts

Anionic surfactant (trade name: NEOGEN SC, manufactured by Dai-Ichi Kogyo Seiyaku Co., Ltd.) 5 parts

Ion exchanged water 200 parts

(Preparation of Magenta Pigment Dispersion)

The following ingredients are mixed, dispersed with a homogenizer (ULTRA TURRAX T50, manufactured by IKA) and ultrasonic vibration, and thus a magenta pigment dispersion having a volume average particle diameter of 150 nm is obtained.

Magenta pigment C. I. Pigment Red 122 (manufactured by Dainichiseika Color & Chemicals Mfg. Co., Ltd.) 50 parts

Anionic surfactant (trade name: NEOGEN SC, manufactured by Dai-Ichi Kogyo Seiyaku Co., Ltd.) 5 parts

Ion exchanged water 200 parts

(Preparation of Cyan Pigment Dispersion)

The following ingredients are mixed, dispersed with a homogenizer (ULTRA TURRAX T50, manufactured by IKA) and ultrasonic vibration, and thus a cyan pigment dispersion having a volume average particle diameter of 150 nm is obtained.

Cyan pigment C. I. Pigment Blue 15:3 (copper phthalocyanine, manufactured by Dainippon Ink And Chemicals, Inc.) 50 parts

Anionic surfactant (trade name: NEOGEN SC, manufactured by Dai-Ichi Kogyo Seiyaku Co., Ltd.) 5 parts

Ion exchanged water 200 parts

(Preparation of Resin Latex)

A styrene-acryl copolymer resin latex (weight average molecular weight: 13,000, resin solid content: 40%, volume average particle diameter: 200 nm, and glass transition temperature: 59° C.) is prepared by the method described below.

Styrene 330 parts

n-butyl acrylate 70 parts

Acrylic acid 6 parts

Dodecanethiol 24 parts

Carbon tetrabromide 4 parts

A solution formed by mixing the above ingredients, and another solution containing 6 parts of a nonionic surfactant (NONIPOL 400, manufactured by Sanyo Chemical Industries, Ltd.) and 10 parts of an anionic surfactant (trade name: NEOGEN R, manufactured by Daiichi Sankyo Company, Limited.) dissolved in 550 parts of ion exchanged water are placed in a flask, dispersed, and emulsified. To the emulsion, a solution of 4 parts of ammonium persulfate dissolved in 50 parts of ion exchanged water is added with slow stirring and mixing for 10 minutes. Thereafter, after the atmosphere in the flask is sufficiently substituted with nitrogen, the mixture is heated to 70° C. in an oil bath with stirring, and emulsion polymerization is continued for 5 hours.

### Example 1

The following composition are placed in a round-bottom stainless steel flask, and mixed and dispersed with a homogenizer (ULTRA TURRAX T50, manufactured by IKA), and then the content in the flask is heated to 45° C. with stirring, and kept at 45° C. for 30 minutes. Thereafter, the pH is adjusted to 7.5 with a sodium hydroxide aqueous solution, the temperature is increased to 90° C., and then the aggregated particles are coalesced over a period of 2 hours. After cooling, the particles are filtered, thoroughly washed with ion exchanged water, dried, and thus yellow toner particles are obtained.

Resin latex 160 parts

Dispersion of optical plasmon resonance particles 1 128 parts

PAC coagulant (trade name: PAC 100W, manufactured by Asada Chemical Industry Co., Ltd.) 1.5 parts

To the yellow toner particles, as external additives, hexamethyldisilazane-treated silica (volume average particle diameter: 40 nm) and a titanium compound (volume average particle diameter: 30 nm) obtained by calcinating a reaction product between metatitanic acid and 50% of isobutyltrimethoxysilane are added at mass ratios of 0.5% and 0.7% with reference to the toner, respectively, and mixed for 10 minutes with a 75-L Henschel mixer, and then sieved with an air flow sieving machine pneumatic classifier HIGH BOLTER 300 (manufactured by Shintokyo Kikai Co., Ltd.), and thus a yellow toner is prepared. The toner has a volume average particle diameter of 5 μm. The proportion of the optical plasmon resonance particles 1 to the total weight of the yellow toner is 10%, and the proportion of the optical plasmon resonance particles 1 to the total volume of the yellow toner is 1% by volume.

0.15 parts of vinylidene fluoride and 1.35 parts of a methyl methacrylate-trifluoroethylene copolymer resin (polymerization molar ratio: 80:20) with respect to 100 parts of ferrite core having a volume average particle diameter of 50 μm are coated using a kneader, and thus a carrier is prepared. The carrier and the yellow toner are mixed at a ratio of 100 parts:8 parts using a 2-liter V blender, and thus an electrostatic latent image developer (yellow) is prepared.

### Example 2

A magenta toner and an electrostatic latent image developer (magenta) are prepared in the same manner as Example 1, except that the dispersion of the optical plasmon resonance particles 1 is replaced with a dispersion of the optical plasmon resonance particles 2. The toner has a volume average particle diameter of 5 μm. The proportion of the optical plasmon resonance particles 2 to the total weight of the magenta toner is 10%, and the proportion of the optical plasmon resonance particles 2 to the total volume of the magenta toner is 1% by volume.

### Example 3

A cyan toner and an electrostatic latent image developer (cyan) are prepared in the same manner as Example 1, except that the dispersion of the optical plasmon resonance particles 1 is replaced with a dispersion of the optical plasmon resonance particles 3. The toner has a volume average particle diameter of 5 μm. The proportion of the optical plasmon resonance particles 3 to the total weight of the cyan toner is 10%, and the proportion of the optical plasmon resonance particles 3 to the total volume of the cyan toner is 1% by volume.

### Comparative Example 1

An yellow toner and an electrostatic latent image developer (yellow) are prepared in the same manner as Example 1, except that the dispersion of the optical plasmon resonance particles 1 is replaced with 3.3 parts of an yellow pigment dispersion. The toner has a volume average particle diameter of 5 μm. The proportion of the yellow pigment to the total weight of the yellow toner is 1%, and the proportion of the yellow pigment to the total volume of the yellow toner is 1% by volume.

### Comparative Example 2

A magenta toner and an electrostatic latent image developer (magenta) are prepared in the same manner as Example 1, except that the dispersion of the optical plasmon resonance particles 1 is replaced with 3.3 parts of a magenta pigment dispersion. The toner has a volume average particle diameter of 5 μm. The proportion of the magenta pigment to the total weight of the magenta toner is 1%, and the proportion of the magenta pigment to the total volume of the magenta toner is 1% by volume.

### Comparative Example 3

A cyan toner and an electrostatic latent image developer (cyan) are prepared in the same manner as Example 1, except that the dispersion of the optical plasmon resonance particles 1 is replaced with 3.3 parts of a cyan pigment dispersion. The toner has a volume average particle diameter of 5 μm. The proportion of the cyan pigment to the total weight of the cyan toner is 1%, and the proportion of the cyan pigment to the total volume of the cyan toner is 1% by volume.

(Evaluation)

Printing is carried out on a paper using each of the toners obtained above in a weight of 2 g/m², and the reflection spectrum is measured using a spectrophotometer (trade name: U4100, manufactured by Hitachi High-Technologies Corporation.), and the color forming density is determined from the minimum reflectance in the visible region. The reflectances of yellow pigment and the yellow optical plasmon resonance particles are 77.3% and 11.3%, the magenta pigment and magenta optical plasmon resonance particles are 74.5 and 12.2%, and the cyan pigment and cyan optical plasmon resonance particles are 86.3% and 8.5%, respectively. These results indicate the three color toners including the optical plasmon resonance particles exhibit a higher color forming density.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A toner comprising a binder resin and metal particles comprising Au, Ag, Cu, Pt, or an alloy thereof having a volume average particle diameter of from about 1 nm to about 300 nm, or an average maximum length of from about 10 nm to about 200 nm.

2. The toner of claim 1, wherein the metal particles are substantially triangular silver particles having a thickness of from about 8 nm to about 12 nm, and a side length of from about 30 nm to about 40 nm.

3. The toner of claim 1, wherein the metal particles are substantially triangular silver particles having a thickness of from about 8 nm to about 12 nm, and a side length of from about 50 nm to about 70 nm.

4. The toner of claim 1, wherein the metal particles are substantially triangular silver particles having a thickness of from about 8 nm to about 12 nm, and a side length of from about 80 nm to about 100 nm.

5. The toner of claim 1, which has a volume average particle diameter of from about 1 μm to about 5 μm.

6. The toner of claim 2, which has a volume average particle diameter of from about 1 μm to about 5 μm.

7. The toner of claim 1, which further comprises a magnetic substance, and has a volume average particle diameter of from about 1 μm to about 3 μm.

8. The toner of claim 2, which further comprises a magnetic substance, and has a volume average particle diameter of from about 1 μm to about 3 μm.

9. An electrostatic latent image developer comprising the toner of claim 1.

10. An electrostatic latent image developer comprising the toner of claim 2.

11. A magnetic latent image developer comprising the toner of claim 7 and a dispersion medium for dispersing the toner.

12. A magnetic latent image developer comprising the toner of claim 8 and a dispersion medium for dispersing the toner.

13. An image forming apparatus comprising an electrostatic latent image holding member, a charging unit for charging the surface of the electrostatic latent image holding member, an electrostatic latent image formation unit for forming an electrostatic latent image on the charged surface of the electrostatic latent image holding member, an image formation unit for developing the electrostatic latent image formed on the surface of the electrostatic latent image holding member using the electrostatic latent image developer of claim 9 thereby forming a toner image, a transfer unit for transferring the toner image formed on the surface of the electrostatic latent image holding member to the surface of a transferred medium, a fixing unit for fixing the transferred toner image on the surface of the transferred medium, and a cleaning unit for removing residual toner from the surface of the electrostatic latent image holding member after the transfer.

14. A toner cartridge detachably mounted on an image forming apparatus, the toner cartridge containing the toner of claim 1 to be fed to an image formation unit provided in the image forming apparatus.

15. A toner cartridge detachably mounted on an image forming apparatus, the toner cartridge containing the toner of claim 2 to be fed to an image formation unit provided in the image forming apparatus.

16. A process cartridge containing the electrostatic latent image developer of claim 9, the process cartridge comprising at least one selected from the group consisting of an image formation unit for developing an electrostatic latent image formed on the surface of an electrostatic latent image holding member using the electrostatic latent image developer thereby forming a toner image, an electrostatic latent image holding member, a charging unit for charging the electrostatic latent image holding member, and a cleaning unit for removing residual toner from the surface of the electrostatic latent image holding member, and the process cartridge being detachably mounted on a main body of an image forming apparatus.

17. An image forming apparatus comprising a magnetic latent image holding member, a magnetic latent image formation unit for forming a magnetic latent image on the surface of the magnetic latent image holding member, a developer storage unit for storing the magnetic latent image developer of claim 11, a developer feeding unit for feeding the magnetic latent image developer to the surface of the magnetic latent image holding member having the magnetic latent image in order to develop the magnetic latent image into a toner image, a transfer unit for transferring the toner image to the surface of a transferred medium, and a demagnetizer for demagnetizing the magnetic latent image on the surface of the magnetic latent image holding member.

18. A process cartridge comprising a magnetic latent image holding member, a developer storage unit for storing the magnetic latent image developer of claim 11, and a developer feeding unit for feeding the magnetic latent image developer to the surface of the magnetic latent image holding member having the magnetic latent image, the process cartridge being detachably mounted on a main body of an image forming apparatus.
